(19) United States
(12) Patent Application Publication
(10) Pub. No.: US 2017/0372499 A1
(43) Pub. Date: Dec. 28, 2017

(54) GENERATING VISUAL CUES RELATED TO VIRTUAL OBJECTS IN AN AUGMENTED AND/OR VIRTUAL REALITY ENVIRONMENT

(71) Applicant: GOOGLE INC., Mountain View, CA (US)

(72) Inventor: Paul Albert LALONDE, Sunnyvale, CA (US)

(21) Appl. No.: 15/386,784

(22) Filed: Dec. 21, 2016

Related U.S. Application Data
(60) Provisional application No. 62/354,985, filed on Jun. 27, 2016.

(51) Int. Cl. G06T 11/60; G06F 3/01

(52) U.S. Cl. CPC G06T 11/60; G06F 3/011

(57) ABSTRACT

In a system for generating visual cues in response to detection of virtual object(s) within as defined proximity and/or area of a user in an augmented and/or virtual reality environment, the system may generate a visual cue if it is determined that a detected virtual object is not physically present in the ambient environment, and may be incorrectly interpreted by the user as capable of providing physical support. The visual cues may include changes in appearance of the detected virtual object, such as eliminating the virtual rendering of the virtual object from the virtual environment displayed by the user, presenting the virtual object in a transparent/translucent, shadowed, highlighted, outlined manner, and the like. When the virtual object is no longer detected within the defined proximity and/or area relative to the user, the system may restore the appearance of the virtual object.

### CROSS REFERENCE TO RELATED APPLICATION(S)

This application is a Non-Provisional of, and claims priority to, U.S. Provisional Application No. 62/354,984, filed on Jun. 27, 2016, the disclosure of which is incorporated herein by reference.

### FIELD

This application relates, generally, to the alteration of appearance of virtual objects in an augmented reality and/or a virtual reality environment.

### BACKGROUND

An augmented reality (AR) system and/or a virtual reality (VR) system may generate a three-dimensional (3D) immersive augmented and/or virtual reality environment. A user may experience this virtual environment through interaction with various electronic devices. For example, a helmet or other head mounted device including a display, glasses or goggles that a user looks through, either when viewing a display device or when viewing the ambient environment, may provide audio and visual elements of the immersive environment to be experienced by a user. A user may move through and interact with elements in the virtual environment through, for example, hand/arm gestures, manipulation of external devices operably coupled to the head mounted device, such as for example a handheld controller, gloves fitted with sensors, and other such electronic devices. User interaction with some virtual objects in the virtual environment, which do not exist in the physical, real world, or ambient environment, may, in some situations pose a hazard to the user, depending on the type of interaction and the type of virtual object.

### SUMMARY

In one aspect, a method may include displaying a virtual environment on a display of a head mounted electronic device worn by a user and operating in an ambient environment, detecting a virtual object within a defined zone relative to the user in the virtual environment, generating a visual cue associated with the detection of the virtual object based on one or more characteristics associated with the detected virtual object, and eliminating the visual cue when the virtual object is no longer detected within the defined zone relative to the user.

In another aspect, a computing device may include a memory storing executable instructions, and a processor configured to execute the instructions. Execution of the instructions may cause the computing device to display a virtual environment on a display of a head mounted electronic device worn by a user and operating in an ambient environment, detect a virtual object within a defined zone relative to the user in the virtual environment, generate a visual cue associated with the detection of the virtual object based on one or more characteristics associated with the detected virtual object, and eliminate the visual cue when the virtual object is no longer detected within the defined zone relative to the user.

The details of one or more implementations are set forth in the accompanying drawings and the description below. Other features will be apparent from the description and drawings, and from the claims.

### BRIEF DESCRIPTION OF THE DRAWINGS

FIGS. 1A-1J illustrate example implementations of the generation of visual cues in response to detection of virtual objects in an augmented reality and/or a virtual reality environment, in accordance with implementations as described herein.

FIG. 2 illustrates an example implementation of detection of a manipulatable virtual object in an augmented reality and/or a virtual reality environment, in accordance with implementations as described herein.

FIG. 3 is an example implementation of an augmented reality and/or a virtual reality system including a head mounted display device and a controller, in accordance with implementations as described herein.

FIGS. 4A and 4B are perspective views of an example head mounted display device, in accordance with implementations as described herein.

FIG. 5 is a block diagram of a system for generating visual cues in response to detection of virtual objects in an augmented reality and/or a virtual reality environment, in accordance with implementations as described herein.

FIG. 6 is a flowchart of a method of generating visual cues in response to detection of virtual objects in an augmented reality and/or a virtual reality environment, in accordance with implementations as described herein.

FIG. 7 shows an example of a computer device and a mobile computer device that can be used to implement the techniques described herein.

### DETAILED DESCRIPTION

A user may experience an augmented reality environment and/or a virtual reality environment generated by for example, a head mounted display (HMD) device. For example, in some implementations, an HMD may block out the ambient environment, so that the virtual environment generated by the HMD is completely immersive, with the user's field of view essentially confined to the virtual environment generated by the HMD and displayed to the user on a display contained within the HMD. In some implementations, this type of HMD may capture 3D image information and/or depth and/or distance information related to the ambient environment, and in particular, related to features in the ambient environment, and may generate and display rendered images of the ambient environment on the display, sometimes together with virtual images or objects, so that the user may maintain some level of situational awareness with respect to the ambient environment while immersed in the virtual environment. In some implementations, this type of HMD may allow for pass through images, for example, captured by an imaging device of the HMD or other imaging device operably coupled within the system, to be displayed on the display of the HMD to maintain situational awareness. In some implementations, at least some portion of the HMD may be transparent or translucent, with virtual images or objects displayed on other portions of the HMD, so that the ambient environment is at least partially visible through the HMD. A user may interact with different applications and/or objects in the AR and/or VR environment generated by the HMD through, for example, hand/arm gestures detected by the HMD, movement and/or manipulation of the HMD itself, manipulation of an external electronic device, and the like.

In some situations, user interaction with some virtual objects in the augmented and/or virtual reality environment may pose a hazard to the user if the user is not aware that the virtual object does not exist in the physical, real world, ambient environment. For example, virtual objects and/or virtual features displayed to the user in the virtual environment, which do not have a corresponding, physical, real world object or feature in the ambient environment, may pose a support hazard to the user in a situation in which, for example, a user attempts to lean on a virtual object, or place a physical, real world object, such as a beverage container, on a virtual object. User interaction with a virtual object or virtual feature posing this type of support hazard may lead to falls, loss of balance, physical objects being dropped and/or broken, and other such hazards.

A system and method, in accordance with implementations as described herein, may generate visual cues to the user as the user moves through the virtual environment, alerting the user to potential hazards posed by virtual objects that are not actually present in the physical, real world, ambient environment. In particular, the visual cues may indicate that an object displayed to the user in the virtual environment poses a potential support hazard, in that the object is virtual, and not rendering of, or pass through image of, a real, physical object in the ambient environment capable of, for example, supporting weight and the like. In some implementations, the system may generate these visual cues when, for example, the virtual object is within a defined distance of the user, such as, for example, within arms reach of the user, or within another defined distance, or volume, defined relative to the user. In some implementations, the visual cues may include, for example, changes in appearance of the virtual object, such as, for example, a fading of the virtual object, a framing or outlining of the virtual object, a highlighting of the virtual object, a disappearance of the virtual object, and other such changes. In some implementations, the change in appearance may affect substantially the entire virtual object. In some implementations, the change in appearance may be applied to portions of the virtual object within the defined distance, or volume, or sphere, relative to the user.

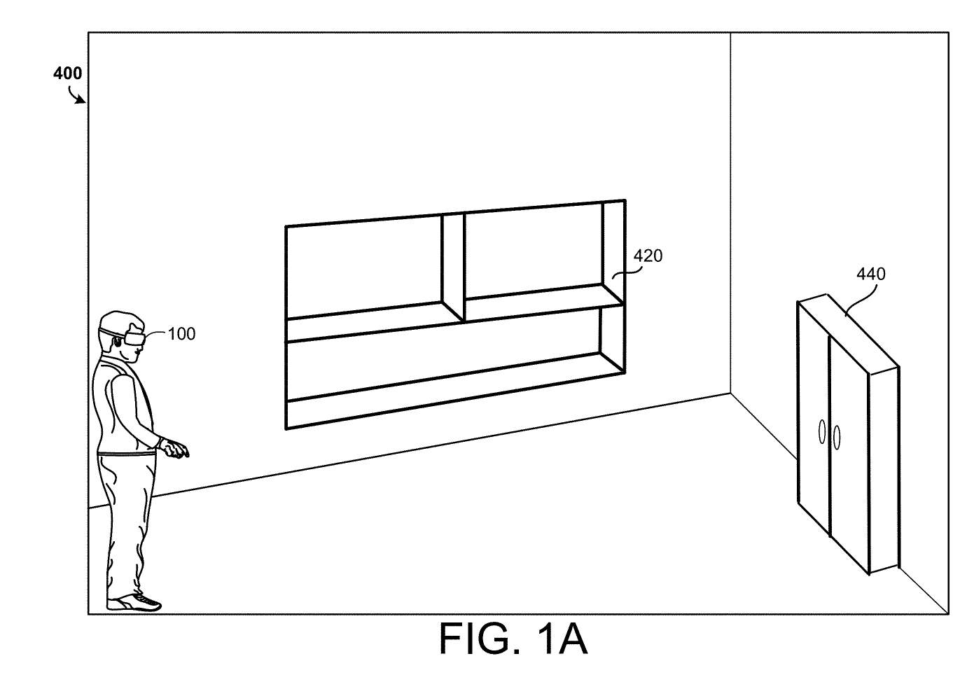

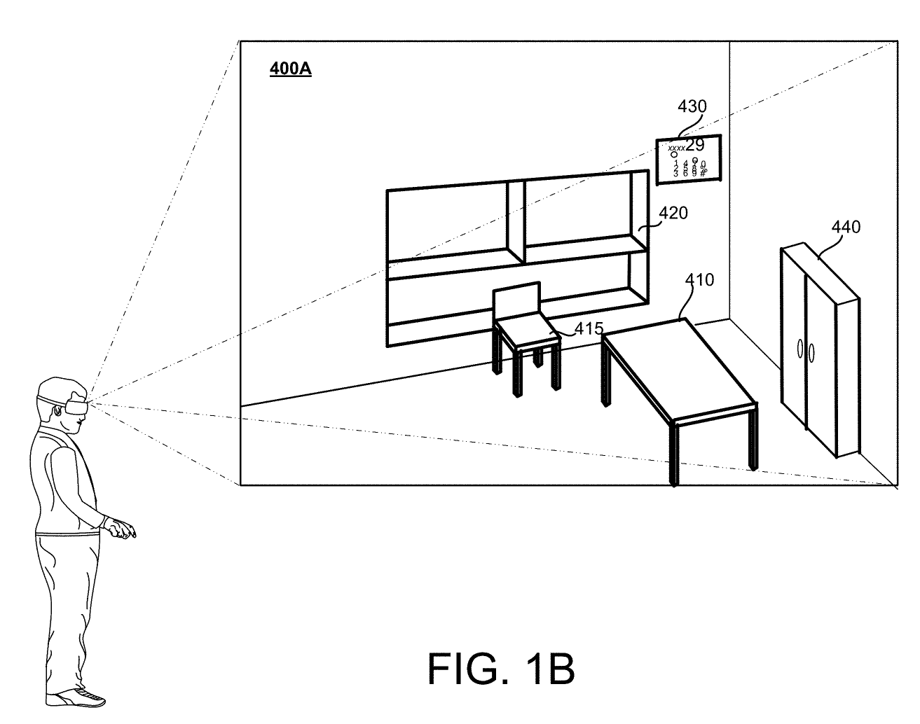

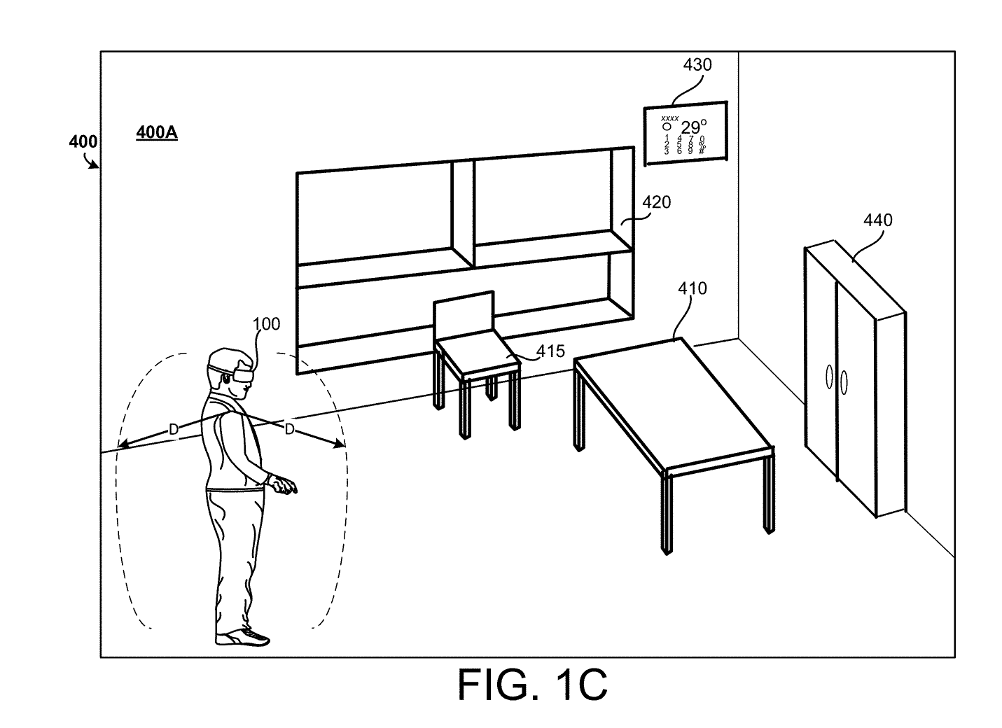

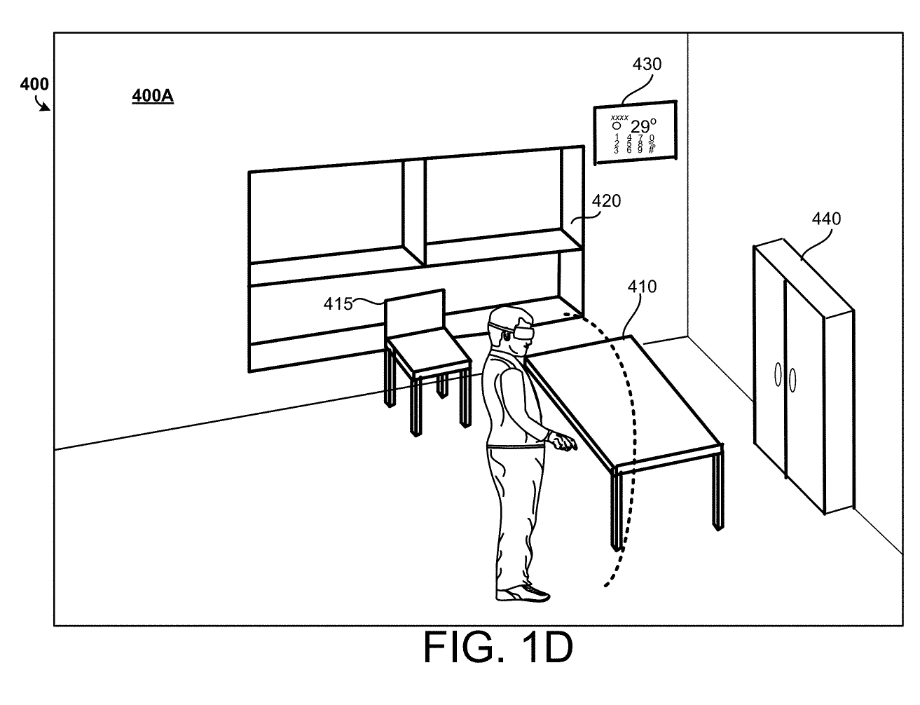

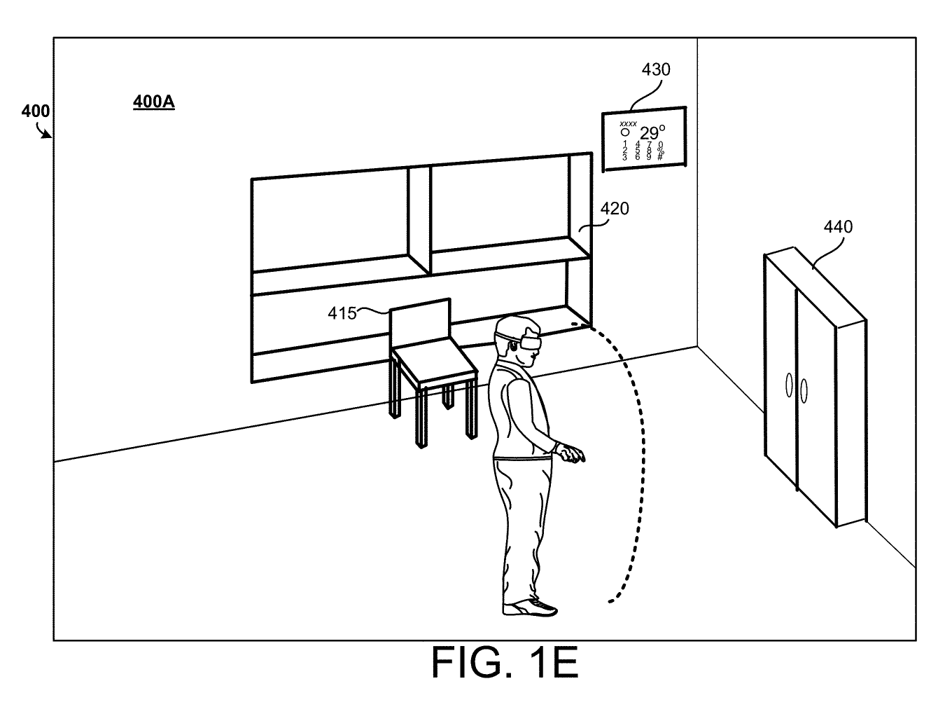

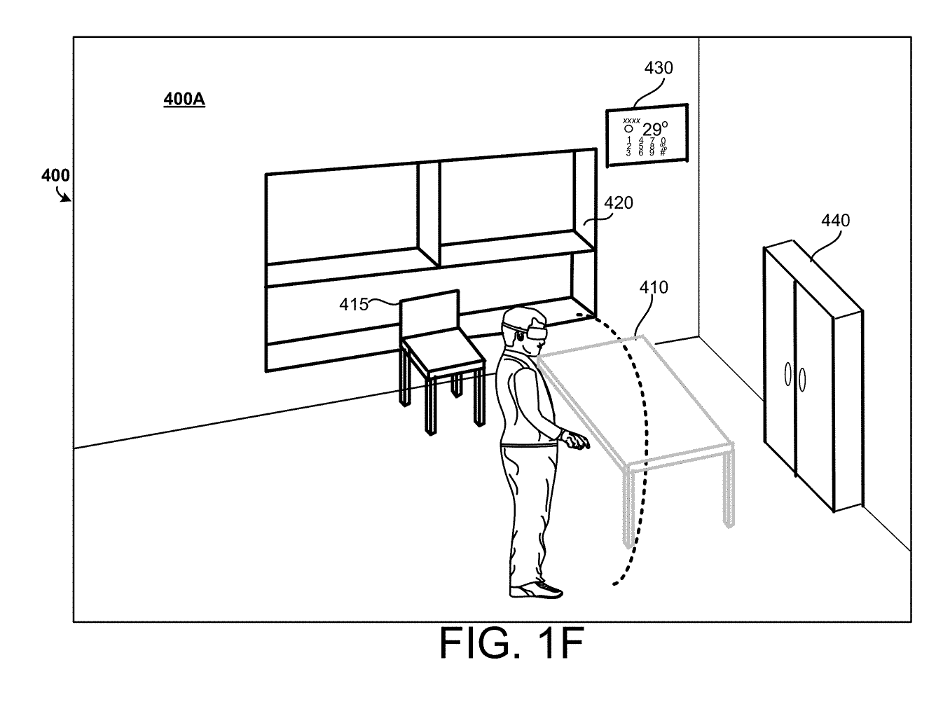

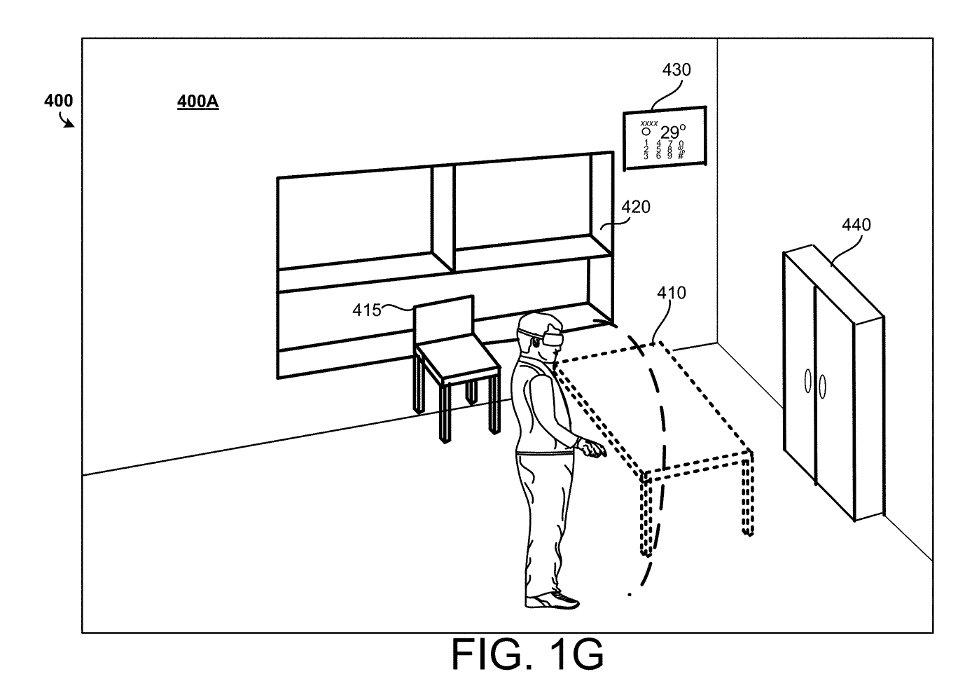

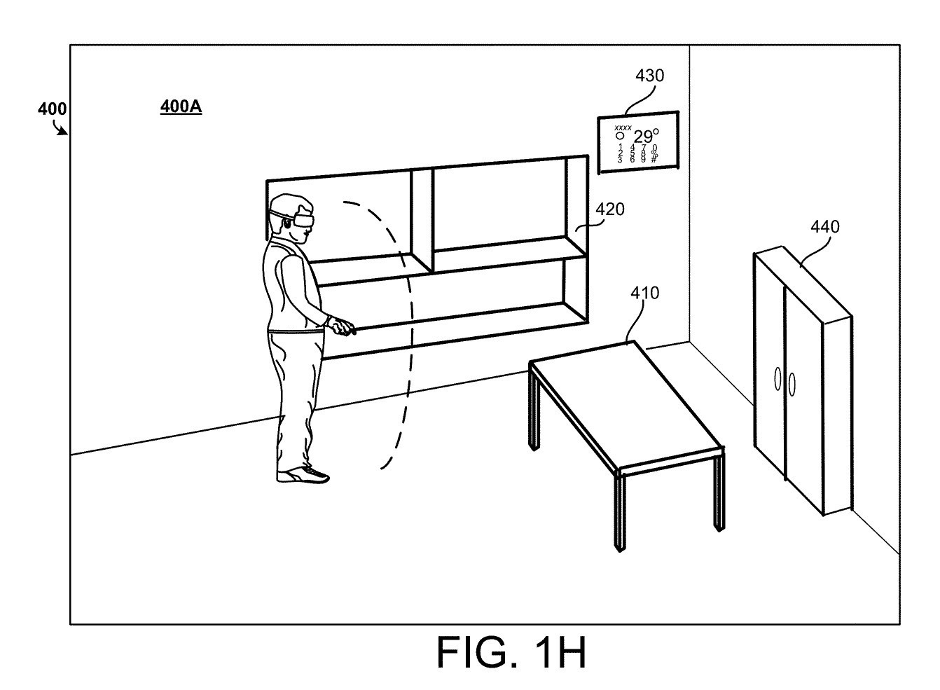

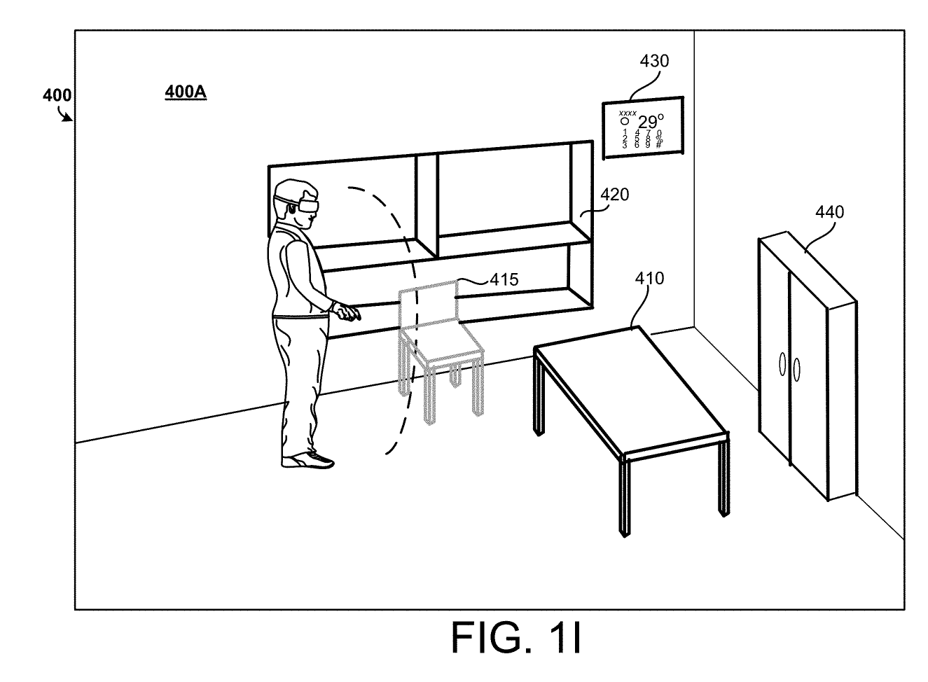

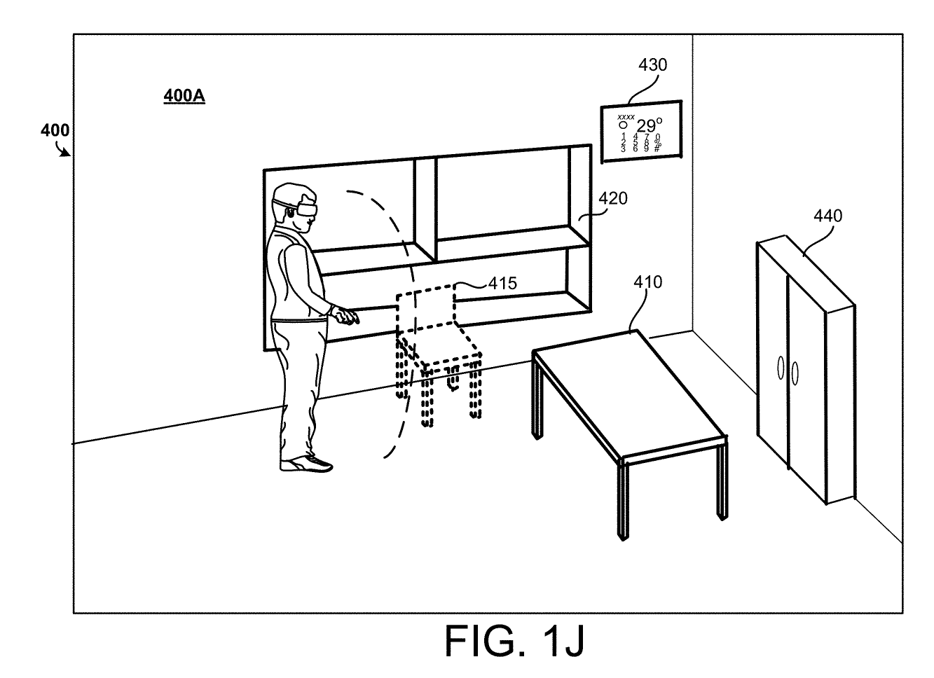

The example implementation shown in FIGS. 1A-1J will be described with respect to a user wearing an HMD that substantially blocks visibility of the ambient environment by the user, so that the HMD generates an augmented reality environment and/or a virtual reality environment, with the user's field of view confined to the virtual environment generated by the HMD. However, the concepts and features described below with respect to FIGS. 1A-1J may also be applied to other types of HMDs, and other types of augmented and/or virtual reality environments as described above.

FIG. 1A illustrates a third person view of a user, wearing an HMD 100, in a space defining the user's current ambient environment 400. In some implementations, the HMD 100 may capture images and/or depth information, and/or collect information related to features in the ambient environment 400, so that the images and objects displayed to the user, for example on a display of the HMD 100, may include both virtual objects related to the virtual the virtual environment 400A generated by the HMD 100 and displayed to the user, as well as renderings of features that are physically present in the ambient environment 400. In some implementations, the images and objects displayed to the user may all be virtual objects, features, elements and the like related to the virtual environment 400A generated and displayed by the HMD 100. FIG. 1B illustrates the virtual environment 400A, as it would be viewed by the user on a display of the HMD 100.

In the example shown in FIG. 1B, a virtual table 410, a virtual chair 415, and a virtual application window 430 (displaying, for example, virtual still and/or moving images, applications and the like) are displayed to the user in the virtual environment 400A generated by the HMD 100. In this example, the virtual table 410, the virtual chair 415, and the virtual application window 430 are not physically present in the ambient environment 400 shown in FIG. 1A. Rather, the virtual table 410, the virtual chair 415, and the virtual application window 430 are virtual objects or virtual features associated with the virtual environment 400A generated by the HMD 100. In the example shown in FIG. 1A, a bookcase 420 and a cabinet 440 are physically present in the ambient environment 400, and images of the bookcase 420 and the cabinet 440 are displayed to the user in the virtual environment 400A shown in FIG. 1B. The images of the bookcase 420 and the cabinet 440 may be, for example, a 3D model of an image of the bookcase 420 and the cabinet 440 in the ambient environment 400, captured by a camera of the HMD 100 and rendered by a processor of the HMD 100, a pass through image of the bookcase 420 and the cabinet 440 in the ambient environment 400, and the like.

In the example shown in FIG. 1A, as the virtual table 410 and the virtual chair 415 are not physically present in the ambient environment 400, the virtual table 410 and the virtual chair 415 may pose a not-there hazard, or support hazard, as the user approaches the virtual table 410 and/or the virtual chair 415. For example, as the user approaches the virtual table 410, the user may attempt to lean on the virtual table 410, causing the user to lose balance and/or fall if it is not clear to the user that the virtual table 410 is a virtual object, and not physically present in the ambient environment 400, and thus not capable of physically supporting the user. Similarly, as the user approaches the virtual table 410, the user may attempt to place an item, such as, for example, a beverage container, a controller, and the like, on the virtual table 410 if it is not clear to the user that the virtual table 410 is a virtual object, and not physically present in the ambient environment 400, and thus not capable of physically supporting an item placed thereon. Likewise, as the user approaches the virtual chair 415, the user may attempt to sit on the virtual chair 415, causing the user to lose balance and/or fall if it is not clear to the user that the virtual chair 415 is a virtual object, and not physically present in the ambient environment 400, and thus not capable of physically supporting the user. Similarly, the user may attempt to place a physical item on the virtual chair 415 if it is not clear to the user that the virtual chair 415 is a virtual object, and not physically present in the ambient environment 400, and thus not capable of physically supporting an item placed thereon.

In contrast, although the virtual display window 430 is a virtual object, and not present in the ambient environment 400, the user is not likely to rely on the virtual display window 430 for any type of physical support, regardless of whether or not the user is in close proximity to the virtual display window 430. The determination as to whether or not a particular virtual object may pose a support hazard, or a not-there hazard, may be made based on numerous different attributes related to the virtual object, such as, for example, the orientation of the virtual surfaces defining the virtual object, the generally accepted functionality of the virtual object, the position of the virtual object relative to the user, and relative to other objects in the virtual environment, and other such factors.

In a system and method, in accordance with implementations as described herein, the system may track the user's movement in the ambient environment 400, and corresponding movement in the virtual environment 400A, and detect when the user is within a defined distance D, or within a defined proximity and/or zone and/or area D, of various virtual objects displayed to the user in the virtual environment 400A. In some implementations, the system may detect and track movement of the user in the ambient environment 400, corresponding to user movement in the virtual environment 400A. The system may use this information to predict the user's impending, or future, movement path and/or position and/or orientation based on, for example, the user's direction and/or velocity, and any obstacles and/or hazards, in the ambient environment 400 and/or in the virtual environment 400A, in the user's predicted path.

In the example shown in FIG. 1C, the defined distance, or proximity/zone/area D relative to the user, is illustrated as a somewhat spherical area surrounding the user, for example, within typical arms reach, corresponding to an approximate distance at which a user may attempt physical/virtual contact with a virtual object displayed in the virtual environment 400A. In the example shown in FIG. 1C, the defined distance, or proximity/zone/area D is illustrated in a manner essentially extending 360 degrees, surrounding the user. Hereinafter, simply for ease of discussion and illustration, the defined distance D, or proximity/zone/area D, will be illustrated in front of the user. Proximity of the user relative to a virtual object posing a not-there hazard, or a support hazard, may be defined in other ways, and the distance or proximity/zone/area D relative to the user shown in FIG. 1C is just one example. In response to detection of a virtual object, within the defined distance or proximity/zone/area D relative to the user, which may pose a not-there hazard as described above, the system may generate a cue, for example, a visual cue, to identify the virtual object as a support hazard, and indicate to the user that the virtual object is not physically present in the ambient environment 400.

As shown in FIG. 1D, as the user approaches the virtual table 410, and the virtual table 410 falls within the defined distance or proximity/zone/area D relative to the user, the system may, for example, modify the rendering of the virtual table 410, as shown in FIGS. 1E-1G, to provide a visual cue to the user that the virtual table 410 is not available for physical support, or cannot provide physical support. In some implementations, the rendering of the virtual table 410 may be removed from the virtual environment 400A displayed to the user, as shown in FIG. 1E, while remaining virtual objects which do not pose a not-there hazard to the user (such as, for example, the virtual application window 430), as well as real, physical objects present in the ambient environment 400 that have been rendered and displayed in the virtual environment 400A (such as the bookcase 420 and the cabinet 440), remain displayed in the virtual environment 400A. In the example shown in FIG. 1E, the virtual chair 415 remains displayed in the virtual environment 400A. Although the virtual chair 415 includes virtual surfaces that could be interpreted by the user as capable of providing physical support, and the generally accepted functionality of a chair includes physical support characteristics, the virtual chair 415 does not fall within the defined distance or proximity/zone/area D relative to the user at which the virtual chair 415 would pose a support hazard, or a not-there hazard, to the user.

In some implementations, as the virtual table 410 is detected within the defined proximity/zone/area D relative to the user, the system may change the appearance of the virtual table 410, so that the virtual table 410 is rendered in a transparent/translucent, shadowed or highlighted manner as shown in FIG. 1F, by dashed or dotted lines as shown in FIG. 1G, or other distinguishing manner. As with the previous example, in the examples shown in FIGS. 1F and 1G, the virtual chair 415, the virtual display window 430, the bookcase 420 and the cabinet 440 may remain displayed to the user in the virtual environment 400A in their current form, as the virtual chair 415, the virtual display window 430, the bookcase 420 and the cabinet 440 do not pose a not-there hazard to the user, particularly at the user's current position.

As described above, with the user positioned as described above, a portion of the virtual table 410 falls within the defined proximity/zone/area D relative to the user. Based on this detected position of the user relative to the virtual objects and elements displayed in the virtual environment (for example, the virtual table 410, virtual chair 415, virtual rendering of the bookcase 420, virtual display window 430, and virtual rendering of the cabinet 440), the system may determine that the virtual table 410 poses a not-there hazard, or support hazard, to the user, and may generate a visual cue alerting the user that the virtual table 410 is not physically present in the ambient environment 400 and is not capable of providing physical support. As shown in FIG. 1H, detection of the virtual rendering of the bookcase 420 (or the virtual rendering of the cabinet 440) within the defined proximity/zone/area D relative to the user would not pose a not-there hazard, as the bookcase 420 and the cabinet 440 are present in the ambient environment 400, and capable of providing physical support to the user.

In the example shown in FIG. 1H, the user has moved away from the virtual table 410, so that the virtual table no longer falls within the defined proximity/zone/area D relative to the user, and thus the virtual table 410 is once again displayed in the normal manner. However, in the example shown in FIG. 1H, the user has moved relative to the virtual environment, so that the virtual chair 415 now falls within the proximity/zone/area D relative to the user, and the system may determine that the virtual chair 415 poses a not-there hazard, or support hazard to the user. In response to this determination, the system may generate a visual cue, alerting the user that the virtual table 410 is not physically present in the ambient environment 400, and not capable of providing physical support. In generating this visual cue, the system may, for example, remove the rendering of the virtual chair 415 from the virtual environment 400A displayed to the user, as shown in FIG. 1H, while remaining virtual objects which do not pose a not-there hazard to the user such as, for example, the virtual application window 430 (which would not be relied upon for physical support), the virtual table 410 (which does not fall within the defined proximity/zone/area D relative to the user), as well as real, physical objects present in the ambient environment 400 that have been rendered and displayed in the virtual environment 400A (such as the bookcase 420 and the cabinet 440), remain displayed in the virtual environment 400A. In some implementations, in generating the visual cue, the system may change the appearance of the virtual chair 415, so that the virtual table 410 is rendered in a transparent/translucent, shadowed or highlighted manner as shown in FIG. 1I, by dashed or dotted lines as shown in FIG. 1J, or other distinguishing manner. As with the previous example, in the examples shown in FIGS. 1I and 1J, the virtual table 410, the virtual display window 430, the virtual rendering of the bookcase 420 and the virtual rendering of the cabinet 440 may remain displayed to the user in the virtual environment 400A in their current form, as the virtual table 410, the virtual display window 430, the bookcase 420 and the cabinet 440 do not pose a not-there hazard to the user, particularly at the user's current position.

In some situations, a virtual object (that is not physically present in the ambient environment 400) may be detected within the defined proximity/zone/area D relative to the user, but the detected virtual object does not have characteristics associated with providing physical support. In this case, detection of the virtual object may not necessarily trigger a change in appearance of the virtual object. For example, the virtual application window 430 may not pose a support hazard, or a not-there hazard, to the user, even when detected within the defined proximity/zone/area D relative to the user, as the virtual application window 430 does not include features associated with providing physical support. Thus, the appearance of the virtual application window 430 may remain unaltered and/or no visual cues generated, even when the virtual application window 430 is detected within the defined proximity/zone/area D relative to the user.

As described above, with the user positioned as shown in FIGS. 1E-1G, a portion of the virtual table 410 falls within the defined proximity/zone/area D relative to the user in the virtual environment 400A. In the examples shown in FIGS. 1E-1G, in response to detection of the virtual table 410 within the defined proximity/zone/area D relative to the user, the system determines that the virtual table 410 poses a not-there hazard, or support hazard, to the user, and generates a visual cue to the user, by eliminating the virtual table 410 from the virtual environment 400A as shown in FIG. 1E, or by altering the appearance of the virtual table 410 in the virtual environment 400A, as in the examples shown in FIGS. 1F and 1G. Similarly, with the user positioned as shown in FIGS. 1H-1J, a portion of the virtual chair 415 falls within the defined proximity/zone/area D relative to the user in the virtual environment 400A, and the system determines that the virtual chair 415 poses a not-there hazard, or support hazard, to the user. In response to this determination, the system generates a visual cue to the user, by eliminating the virtual chair 415 from the virtual environment 400A as shown in FIG. 1h, or by altering the appearance of the virtual chair 415 in the virtual environment 400A, as in the examples shown in FIGS. 1I and 1J. In some implementations, the system may eliminate, or alter the appearance of, only the portion of the virtual object (for example, the virtual table 410 and/or the virtual chair 415) falling within the defined proximity area/area D relative to the user, so that, as the user moves through the virtual environment 400A, only portions of the virtual object falling within the defined proximity/zone/area D relative to the user are affected by the change in appearance, while the appearance of remaining portions of the virtual object are maintained in and/or restored to their original rendered state.

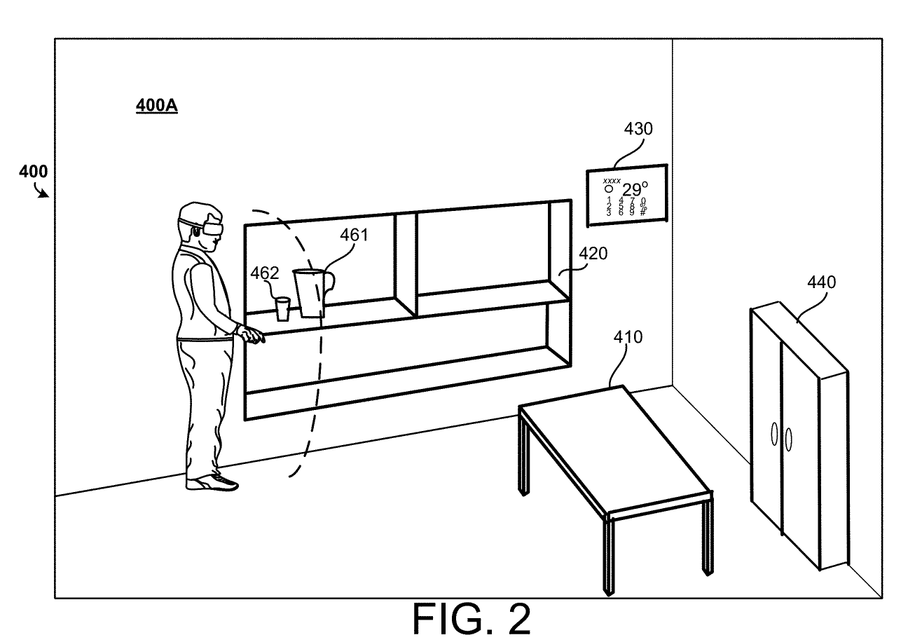

In some implementations, the system may differentiate between the various virtual objects rendered for display to the user in the virtual environment 400, that are not physically present in the ambient environment 400, to determine whether or not visual cue(s) are to be generated to identify the virtual objects as potential support hazards as the virtual objects are detected within the defined proximity/zone/area D relative to the user. For example, the system may identify relatively small, manipulatable virtual objects intended for interaction with and manipulation by the user, but unlikely to be leaned on, sat upon, or otherwise relied upon for support of the user or other, real world objects. For example, as shown in FIG. 2, relatively small virtual objects 461 and 462, which are not physically present in the ambient environment 400, are positioned on a surface of the virtual rendering of the bookcase 420, which is physically present in the ambient environment 400.

As the user approaches the bookcase 420, the virtual chair 415 is eliminated from the virtual environment (as the virtual chair 415 would pose a support hazard, or not-there hazard, to the user as described in detail above), and the appearance of the virtual rendering of the bookcase 420 in the virtual environment 400A is not changed/no visual cues are generated, as the bookcase 420 does not pose a support hazard, or not-there hazard, to the user, even when the bookcase 420 is detected within the defined proximity/zone/area D relative to the user. Similarly, in the example shown in FIG. 2, the virtual objects 461 and 462 (a glass and a pitcher, in this example) are also detected within the defined proximity/zone/area D relative to the user. The virtual objects 461 and 462 are relatively small, are intended for manipulation by/interaction with the user, and do not include features and/or characteristics associated with providing physical support. Thus, in this situation, the appearance of the virtual objects 461 and 462 are not altered/visual cues are not generated, as, based on various attributes and characteristics of the virtual objects 461 and 462, it is determined that the virtual objects 461 and 462 do not pose a support hazard, or not-there hazard, to the user.

In a system and method, in accordance with implementations described herein, visual cues may be generated and displayed to a user as the user moves in a virtual environment and a virtual object which may pose a support hazard, or not-there hazard, to the user is detected within a defined proximity/zone/area relative to the user. It may be determined that the detected virtual object poses a support hazard, or a not-there hazard, to the user if the virtual object represents an object which may be interpreted by the user as capable of providing physical support, but the object is not physically present in the ambient environment, and thus cannot actually provide physical support. These visual cues may include various different types of changes in appearance of some, or all, of the detected virtual object. As the user continues to move, and the virtual object identified as a potential support hazard is no longer detected within the defined proximity/zone/area relative to the user, the visual cues may be removed and/or the appearance of the virtual object may be restored. These types of visual cues may provide an organic indication of a potential support hazard, or not-there hazard, to the user, compared to a text or audible warning, may facilitate user interaction in the augmented reality/virtual reality environment and enhancing the user's experience in the virtual environment, while allowing the user to avoid support hazards which may detract from the user's experience.

In the example implementations described above, the user is engaged in an augmented and/or virtual reality experience, in which elements of the real world, ambient environment, are combined with virtual object in a virtual environment to be experienced by the user. In an augmented reality experience, this may be achieved by, for example, a system that inserts virtual objects into the user's view of the ambient environment. In some implementations, this may be achieved by, for example, a system that inserts virtual objects into a 3D virtual model of the user's ambient environment. In these examples, the system may provide visual cues, in the form of, for example, a change in appearance of a virtual object, when the user approaches and the system detects a virtual object within the defined proximity/zone/area relative to the user that may present a not-there hazard, or support hazard, to the user, as described above in detail. However, in some implementations, the virtual environment generated by the HMD may be a complete departure from the ambient environment in which the user and the system are operating. In this situation, in which a virtual environment that is completely separate from the ambient environment, is generated and displayed to the user, a system and method, in accordance with embodiments as described here, may provide visual cues to the user in a similar manner. That is, for example, when detecting a virtual object within the defined proximity/zone/area relative to the user, the system may alter the appearance of the virtual object as described above if the virtual object presents a not-there hazard, or a support hazard, to the user. In some implementations, the system may scan the ambient environment and, f the system detects that the user approaches a real world, physical object, for example, in the defined proximity/zone/area relative to the user, which may pose an obstacle to the user, the system may present a visual cue to the user indicating the presence of the physical object. For example, the system may display a rendering of the physical object in the virtual environment, or may display pass through still and/or moving images to the user, to alert the user to the presence of the physical object in the ambient environment, allowing the user to avoid the obstacle.

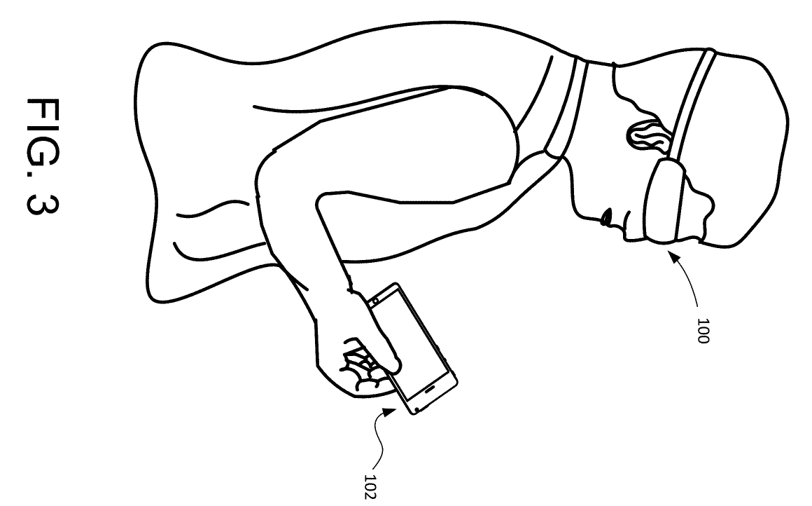

As noted above, the augmented reality environment and/or virtual reality environment may be generated by a system including, for example, an HMD 100 worn by a user, as shown in FIG. 3. As discussed above, the HMD 100 may be controlled by various different types of user inputs, and the user may interact with the augmented reality/virtual reality environment generated by the HMD 100 through various different types of user inputs, including, for example, hand/arm gestures, head gestures, manipulation of the HMD 100, manipulation of a portable controller 102 operably coupled to the HMD 100, and the like.

### Example

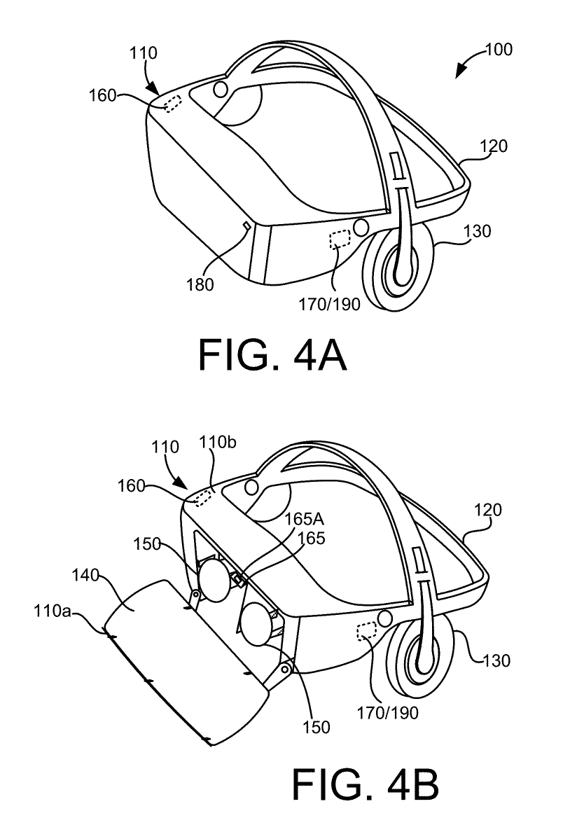

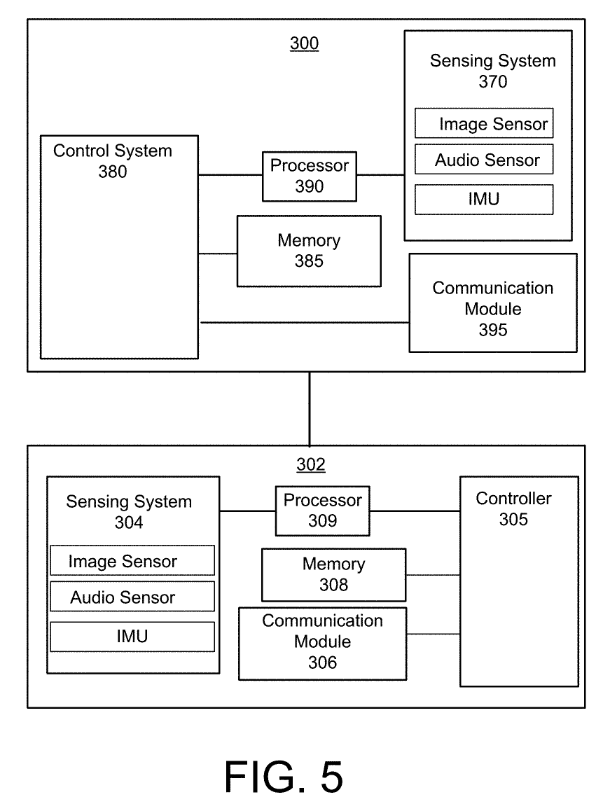

FIGS. 4A and 4B are perspective views of an example HMD, such as, for example, the HMD 100 worn by the user in FIG. 3. FIG. 5 is a block diagram of an augmented reality or virtual reality system including a first electronic device 300 in communication with a second electronic device 302. The first electronic device 300 may be, for example an HMD as shown in FIGS. 3, 4A and 4B, generating an augmented/virtual reality environment, and the second electronic device 302 may be, for example, a controller 102 as shown in FIG. 3.

As shown in FIGS. 4A and 4B, the example HMD 100 may include a housing 110 coupled to a frame 120, with an audio output device 130 including, for example, speakers mounted in headphones, coupled to the frame 120. In FIG. 4B, a front portion 110a of the housing 110 is rotated away from a base portion 110b of the housing 110 so that some of the components received in the housing 110 are visible. A display 140 may be mounted on an interior facing side of the front portion 110a of the housing 110. Lenses 150 may be mounted in the housing 110, between the user's eyes and the display 140 when the front portion 110a is in the closed position against the base portion 110b of the housing 110. In some implementations, the HMD 100 may include a sensing system 160 including various sensors such as, for example, audio sensor(s), image/light sensor(s), positional sensors (e.g., inertial measurement unit including gyroscope and accelerometer), and the like. The HMD 100 may also include a control system 170 including a processor 190 and various control system devices to facilitate operation of the HMD 100.

In some implementations, the HMD 100 may include an image sensor, or a camera 180, to capture still and moving images, and/or distance/depth data related to features in the ambient environment. The images captured by the camera 180 may be used to help track a physical position of the user and/or the controller 102, and/or may be displayed to the user on the display 140 in a pass through mode, and/or may provide information used by the system to generate a 3D model of the ambient environment. In some implementations, the HMD 100 may include a gaze tracking device 165 including one or more image sensors 165A to detect and track an eye gaze of the user. In some implementations, the HMD 100 may be configured so that the detected gaze is processed as a user input to be translated into a corresponding interaction in the augmented reality/virtual reality environment.

As shown in FIG. 5, the first electronic device 300 may include a sensing system 370 and a control system 380, which may be similar to the sensing system 160 and the control system 170, respectively, shown in FIGS. 4A and 4B. The sensing system 370 may include, for example, a light sensor, an audio sensor, an image sensor, a distance/proximity sensor, a positional sensor, and/or other sensors and/or different combination(s) of sensors, including, for example, an image sensor positioned to detect and track the user's eye gaze, such as the gaze tracking device 165 shown in FIG. 4B. The control system 380 may include, for example, a power/pause control device, audio and video control devices, an optical control device, a transition control device, and/or other such devices and/or different combination(s) of devices. The sensing system 370 and/or the control system 380 may include more, or fewer, devices, depending on a particular implementation, and may have a different physical arrangement that shown. The first electronic device 300 may also include a processor 390 in communication with the sensing system 370 and the control system 380, a memory 385, and a communication module 395 providing for communication between the first electronic device 300 and another, external device, such as, for example, the second electronic device 302.

The second electronic device 302 may include a communication module 306 providing for communication between the second electronic device 302 and another, external device, such as, for example, the first electronic device 300. The second electronic device 302 may include a sensing system 304 including an image sensor and an audio sensor, such as is included in, for example, a camera and microphone, an inertial measurement unit, a touch sensor such as is included in a touch sensitive surface of a controller, or smartphone, and other such sensors and/or different combination(s) of sensors. A processor 309 may be in communication with the sensing system 304 and a control unit 305 of the second electronic device 302, the control unit 305 having access to a memory 308 and controlling overall operation of the second electronic device 302.

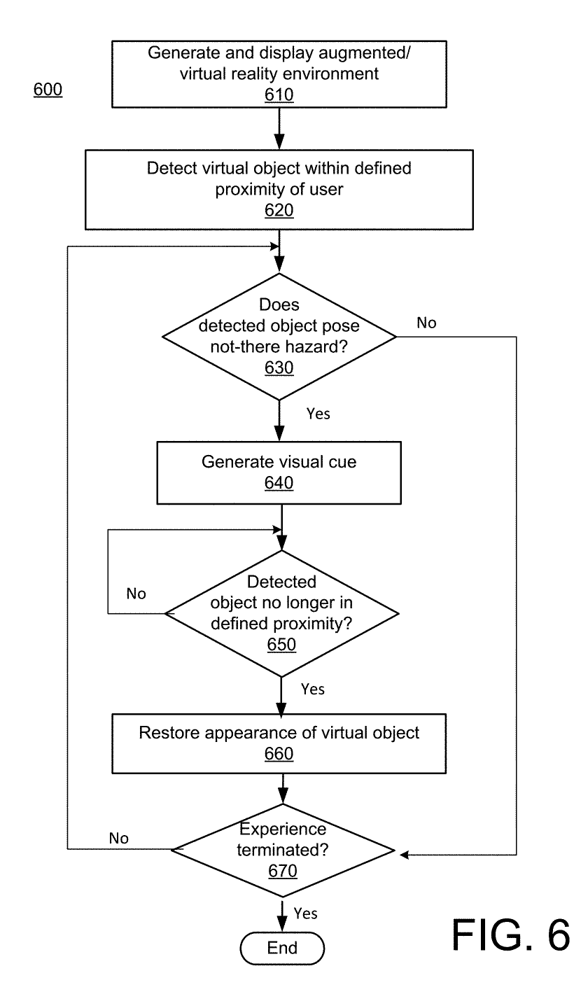

A method 600 of generating visual cues in response to virtual objects, detected within a defined proximity and/or area of a user in an augmented and/or virtual reality environment, in accordance with implementations described herein, is shown in FIG. 6.

A user may initiate an augmented reality experience and/or a virtual reality experience in an ambient environment, or real world space, using, for example, a computing device such as, for example, a head mounted display device, to generate an augmented reality/virtual reality environment (block 610). The augmented and/or virtual reality environment may include one or more virtual objects rendered and displayed to the user, for example, on a display of the HMD, and one or more renderings of objects which are physically present in the ambient environment that are rendered and displayed to the user, for example, on the display of the HMD, together with the virtual objects, in the virtual environment. If the system detects that one (or more) of these virtual objects is within a defined distance, or proximity, or zone, or area, relative to the user (block 620), the system may determine whether or not the detected virtual object poses a not-there hazard to the user (block 630). The system may determine that the detected virtual object poses a not there hazard if, for example, the detected virtual object is not physically present in the ambient environment, and includes features which the user would interpret as capable of providing physical support, as described above in detail with respect to FIGS. 1A-1J and 2. In response to the determination that the detected virtual object may pose a not-there hazard to the user, the system may generate a visual cue (block 640) alerting the user that the virtual object is not available for providing physical support. These visual cues may include, for example, eliminating some or all of the rendering of the virtual object from the virtual environment, and/or altering some or all of the appearance of the detected virtual object, as described above in detail with respect to FIGS. 1A-1J and 2. Once the virtual object is no longer detected within the defined distance, or proximity, or area, relative to the user (block 650), the system may restore the appearance of the virtual rendering of the virtual object in the virtual environment (block 660). The process may continue until it is determined that the current augmented reality/virtual reality experience has been terminated (block 670).

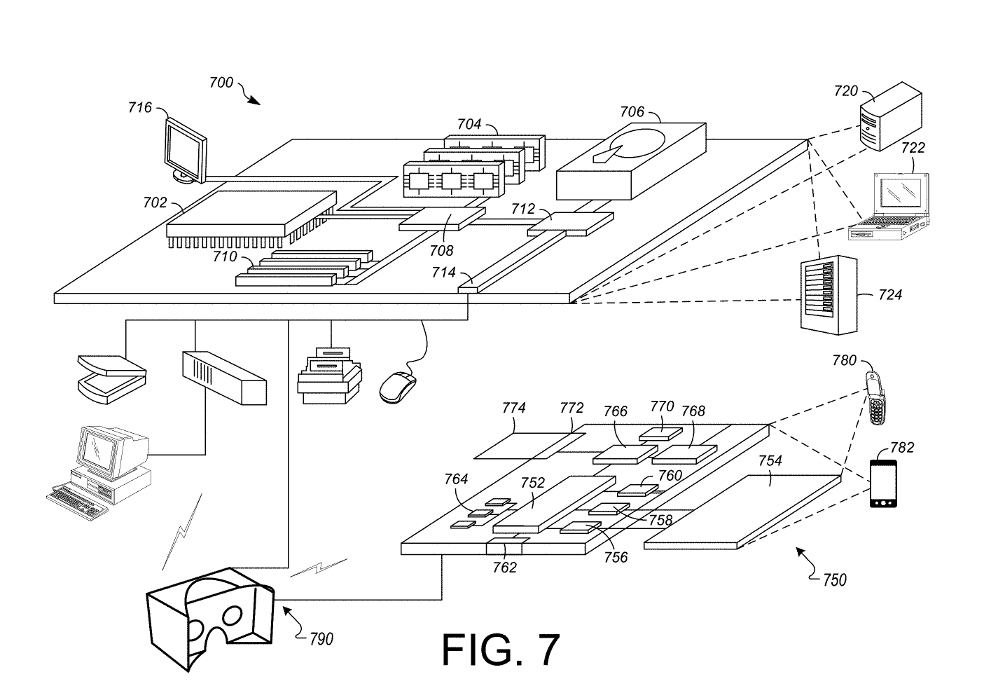

FIG. 7 shows an example of a computer device 700 and a mobile computer device 750, which may be used with the techniques described here. Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 is capable of providing mass storage for the computing device 700. In one implementation, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 704, the storage device 706, or memory on processor 702.

The high speed controller 708 manages bandwidth-intensive operations for the computing device 700, while the low speed controller 712 manages lower bandwidth-intensive operations. Such allocation of functions is exemplary only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD (Thin-Film-Transistor Liquid Crystal Display) or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provide in communication with processor 752, so as to enable near area communication of device 750 with other devices. External interface 762 may provide, for example, for wired communication in some implementations, or for wireless communication in other implementations, and multiple interfaces may also be used.

The memory 764 stores information within the computing device 750. The memory 764 can be implemented as one or more of a computer-readable medium or media, a volatile memory unit or units, or a non-volatile memory unit or units. Expansion memory 774 may also be provided and connected to device 750 through expansion interface 772, which may include, for example, a SIMM (Single In Line Memory Module) card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provide as a security module for device 750, and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, or memory on processor 752, that may be received, for example, over transceiver 768 or external interface 762.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, Wi-Fi, or other such transceiver (not shown). In addition, GPS (Global Positioning System) receiver module 770 may provide additional navigation- and location-related wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smart phone 782, personal digital assistant, or other similar mobile device.

Various implementations of the systems and techniques described here can be reali7ed in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the computing devices depicted in FIG. 7 can include sensors that interface with a virtual reality (VR headset/HMD device 790). For example, one or more sensors included on a computing device 750 or other computing device depicted in FIG. 7, can provide input to VR headset 790 or in general, provide input to a VR space. The sensors can include, but are not limited to, a touchscreen, accelerometers, gyroscopes, pressure sensors, biometric sensors, temperature sensors, humidity sensors, and ambient light sensors. The computing device 750 can use the sensors to determine an absolute position and/or a detected rotation of the computing device in the VR space that can then be used as input to the VR space. For example, the computing device 750 may be incorporated into the VR space as a virtual object, such as a controller, a laser pointer, a keyboard, a weapon, etc. Positioning of the computing device/virtual object by the user when incorporated into the VR space can allow the user to position the computing device so as to view the virtual object in certain manners in the VR space. For example, if the virtual object represents a laser pointer, the user can manipulate the computing device as if it were an actual laser pointer. The user can move the computing device left and right, up and down, in a circle, etc., and use the device in a similar fashion to using a laser pointer.

In some implementations, one or more input devices included on, or connect to, the computing device 750 can be used as input to the VR space. The input devices can include, but are not limited to, a touchscreen, a keyboard, one or more buttons, a trackpad, a touchpad, a pointing device, a mouse, a trackball, a joystick, a camera, a microphone, earphones or buds with input functionality, a gaming controller, or other connectable input device. A user interacting with an input device included on the computing device 750 when the computing device is incorporated into the VR space can cause a particular action to occur in the VR space.

In some implementations, a touchscreen of the computing device 750 can be rendered as a touchpad in VR space. A user can interact with the touchscreen of the computing device 750. The interactions are rendered, in VR headset 790 for example, as movements on the rendered touchpad in the VR space. The rendered movements can control virtual objects in the VR space.

In some implementations, one or more output devices included on the computing device 750 can provide output and/or feedback to a user of the VR headset 790 in the VR space. The output and feedback can be visual, tactical, or audio. The output and/or feedback can include, but is not limited to, vibrations, turning on and off or blinking and/or flashing of one or more lights or strobes, sounding an alarm, playing a chime, playing a song, and playing of an audio file. The output devices can include, but are not limited to, vibration motors, vibration coils, piezoelectric devices, electrostatic devices, light emitting diodes (LEDs), strobes, and speakers.

In some implementations, the computing device 750 may appear as another object in a computer-generated, 3D environment. Interactions by the user with the computing device 750 (e.g., rotating, shaking, touching a touchscreen, swiping a finger across a touch screen) can be interpreted as interactions with the object in the VR space. In the example of the laser pointer in a VR space, the computing device 750 appears as a virtual laser pointer in the computer-generated, 3D environment. As the user manipulates the computing device 750, the user in the VR space sees movement of the laser pointer. The user receives feedback from interactions with the computing device 750 in the VR environment on the computing device 750 or on the VR headset 790.

In some implementations, a computing device 750 may include a touchscreen. For example, a user can interact with the touchscreen in a particular manner that can mimic what happens on the touchscreen with what happens in the VR space. For example, a user may use a pinching-type motion to zoom content displayed on the touchscreen. This pinching-type motion on the touchscreen can cause information provided in the VR space to be zoomed. In another example, the computing device may be rendered as a virtual book in a computer-generated, 3D environment. In the VR space, the pages of the book can be displayed in the VR space and the swiping of a finger of the user across the touchscreen can be interpreted as turning/flipping a page of the virtual book. As each page is turned/flipped, in addition to seeing the page contents change, the user may be provided with audio feedback, such as the sound of the turning of a page in a book.

In some implementations, one or more input devices in addition to the computing device (e.g., a mouse, a keyboard) can be rendered in a computer-generated, 3D environment. The rendered input devices (e.g., the rendered mouse, the rendered keyboard) can be used as rendered in the VR space to control objects in the VR space.

Computing device 700 is intended to represent various forms of digital computers and devices, including, but not limited to laptops, desktops, workstations, personal digital assistants, servers, blade servers, mainframes, and other appropriate computers. Computing device 750 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

A number of embodiments have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A method, comprising:
displaying a virtual environment on a display of head mounted electronic device worn by a user and operating in an ambient environment;
detecting a virtual object within a defined zone relative to the user in the virtual environment;
generating a visual cue associated with the detection of the virtual object based on one or more characteristics associated with the detected virtual object; and
eliminating the visual cue when the virtual object is no longer detected within the defined zone relative to the user.

2. The method of claim 1, generating a visual cue associated with the detection of the virtual object based on one or more characteristics associated with the detected virtual object including:
determining whether or not the detected virtual object is a support hazard; and
generating the visual cue if it is determined that the detected virtual object is a support hazard.

3. The method of claim 2, determining whether or not the detected virtual object is a support hazard including determining that the detected virtual object is a support hazard when:
the detected virtual object is a virtual rendering of a virtual object present only in the virtual environment; and
the virtual rendering of the detected virtual object includes a virtual rendering of one or more virtual support features.

4. The method of claim 2, determining whether or not the detected virtual object is a support hazard including determining that the detected virtual object is not a support hazard when:
the detected virtual object is a virtual rendering of a virtual object present only in the virtual environment; and
the detected virtual object is manually manipulatable through user interaction with the detected virtual object.

5. The method of claim 2, determining whether or not the detected virtual object is a support hazard including determining that the detected virtual object is not a support hazard when:
the detected virtual object is a virtual rendering of a physical object present in the ambient environment.

6. The method of claim 2, generating a visual cue including at least one of:
eliminating a virtual rendering of the virtual object from the virtual environment; or
altering an appearance of the virtual rendering of the virtual object in the virtual environment.

7. The method of claim 6, eliminating a virtual rendering of the virtual object including eliminating the virtual rendering of the virtual object from the virtual environment only while the virtual object remains within the defined zone relative to the user, and
altering an appearance of the virtual rendering of the virtual object including altering the appearance of the virtual rendering of the virtual object only while the virtual object remains within the defined zone relative to the user.

8. The method of claim 6, altering an appearance of the virtual rendering of the virtual object including rendering the virtual object in a translucent form, or rendering the virtual object in a dashed or dotted outline form.

9. The method of claim 2, generating a visual cue including at least one of:
eliminating only a portion of a virtual rendering of the virtual object that is detected within the defined zone; or
altering an appearance of only the portion of the virtual rendering of the virtual object that is detected within the defined zone.

10. The method of claim 9, eliminating only a portion of a virtual rendering of the virtual object that is detected within the defined zone, or altering an appearance of only the portion of the virtual rendering of the virtual object detected within the defined zone including:
updating only the portion of the virtual object that is detected within the defined zone as the user moves relative to the virtual object;
eliminating only the updated portion of the virtual rendering, or altering the appearance of only the updated portion of the virtual rendering, detected within the defined zone as the user moves relative to the virtual object; and
restoring the appearance of remaining portions of the virtual object.

11. A computing device, comprising:
a memory storing executable instructions; and
a processor configured to execute the instructions, to cause the computing device to:
display a virtual environment on a display of a head mounted electronic device worn by a user and operating in an ambient environment;
detect a virtual object within a defined zone relative to the user in the virtual environment;
generate a visual cue associated with the detection of the virtual object based on one or more characteristics associated with the detected virtual object; and
eliminate the visual cue when the virtual object is no longer detected within the defined zone relative to the user.

12. The computing device of claim 11, wherein, in generating a visual cue, the execution of the instructions cause the computing device to:
determine whether or not the detected virtual object is a support hazard; and
generate the visual cue if it is determined that the detected virtual object is a support hazard.

13. The computing device of claim 12, wherein, in determining whether or not the detected virtual object is a support hazard, the execution of the instructions may cause the computing device to determine that the detected virtual object is a support hazard when:
the detected virtual object is a virtual rendering of a virtual object present only in the virtual environment; and
the virtual rendering of the detected virtual object includes a virtual rendering of one or more virtual support features.

14. The computing device of claim 12, wherein, in determining whether or not the detected virtual object is a support hazard, the execution of the instructions may cause the computing device to determine that the detected virtual object is not a support hazard when:
the detected virtual object is a virtual rendering of a virtual object present only in the virtual environment; and
the detected virtual object is manually manipulatable through user interaction with the detected virtual object.

15. The computing device of claim 12, wherein, in determining whether or not the detected virtual object is a support hazard, the execution of the instructions may cause the computing device to determine that the detected virtual object is not a support hazard when:
the detected virtual object is a virtual rendering of a physical object present in the ambient environment.

16. The computing device of claim 12, wherein, in generating a visual cue, the execution of the instructions cause the computing device to:
eliminate a virtual rendering of the virtual object from the virtual environment; or
alter an appearance of the virtual rendering of the virtual object in the virtual environment.

17. The computing device of claim 16, wherein, in eliminating a virtual rendering of the virtual object, the execution of the instructions cause the computing device to eliminate the virtual rendering of the virtual object from the virtual environment only while the virtual object remains within the defined zone relative to the user, and
in altering an appearance of the virtual rendering of the virtual object, the execution of the instructions cause the computing device to alter the appearance of the virtual rendering of the virtual object only while the virtual object remains within the defined zone relative to the user.

18. The computing device of claim 16, wherein, in altering an appearance of the virtual rendering of the virtual object, the execution of the instructions cause the computing device to render the virtual object in a translucent form, or to render the virtual object in a dashed or dotted outline form.

19. The computing device of claim 12, wherein, in generating a visual cue, the execution of the instructions cause the computing device to:
eliminate only a portion of a virtual rendering of the virtual object that is detected within the defined zone; or
alter an appearance of only the portion of the virtual rendering of the virtual object that is detected within the defined zone.

20. The computing device of claim 19, wherein, in eliminating only a portion of a virtual rendering of the virtual object that is detected within the defined zone, or altering an appearance of only the portion of the virtual rendering of the virtual object detected within the defined zone, the execution of the instructions cause the computing device to:
update the portion of the virtual object that is detected within the defined zone as the user moves relative to the virtual object;
eliminate only the updated portion of the virtual rendering, or alter the appearance of only the updated portion of the virtual rendering, detected within the defined zone as the user moves relative to the virtual object; and
restoring the appearance of remaining portions of the virtual object.
